(19) United States
(12) Patent Application Publication
(10) Pub. No.: US 2013/0233775 A1
(43) Pub. Date: Sep. 12, 2013

(54) BILL STORAGE AND BILL HANDLING APPARATUS

(71) Applicant: HITACHI-OMRON TERMINAL SOLUTIONS CORP., TOKYO (JP)

(72) Inventors: Akihiro NAGURA, Nagakute (JP); Sho MIZUNO, Nagoya (JP)

(73) Assignee: HITACHI-OMRON TERMINAL SOLUTIONS CORP., TOKYO (JP)

(21) Appl. No.: 13/871,413

(22) Filed: Apr. 26, 2013

Related U.S. Application Data
(63) Continuation of application No. 13/005,314, filed on Jan. 12, 2011, now Pat. No. 8,454,009.

(30) Foreign Application Priority Data
Jan. 13, 2010 (JP) 2010-004520

(51) Int. Cl. G07F 19/00

(52) U.S. Cl. CPC G07F 19/202
USPC 209/534; 271/3.14

(57) ABSTRACT

A bill storage comprises: a plurality of bill receipt portions provided therein; a bill inlet-outlet, which is provided on an upper surface of the bill storage and through which bills are taken out or received from outside; and a taking-out and accumulating mechanism part provided on each of the receipt portions to perform actions, in which bills are taken out and in which bills are accumulated, wherein at least a first bill receipt portion and a second bill receipt portion are arranged in a state of being stacked in this order from a side of the bill inlet-outlet, the bill inlet-outlet is provided on a predetermined side, and the taking-out and accumulating mechanism part provided on the first bill receipt portion is arranged on another side opposed to the predetermined side.

### CROSS-REFERENCE TO RELATED PATENT APPLICATIONS

Japan Priority Application 2010-004520, filed Jan. 13, 2010 including the specification, drawings, claims and abstract, is incorporated herein by reference in its entirety. This application is a Continuation of U.S. application Ser. No. 13/005,314, filed Jan. 12, 2011, incorporated herein by reference in its entirety.

### BACKGROUND OF THE INVENTION

The present invention relates to a bill handling apparatus installed in an automatic teller machine (ATM) mounted in, for example, a financial institution or the like, and a bill storage mounted in the bill handling apparatus.

Conventionally, a bill handling apparatus is installed in an automatic teller machine used in a financial institution or the like. Such bill handling apparatus comprises a bill receipt/payment port, through which a user charges and takes out a bill, a bill discrimination unit, which discriminates a bill being received or paid, a temporary holding box, which temporarily receives a bill as received until an associated transaction is realized, a bill storage, which receives and holds a bill, and a bill conveyance path, through which a bill is conveyed to the respective units or boxes.

The bill storage includes a reject box for receipt of rejected bill, which is discriminated by the bill discrimination unit not to meet a predetermined reference, a recycling box, in which bill for receipt and payment is received every denomination, and a loading box, which serves for replenishing of bill to the recycling box and for recovery of bill from the recycling box.

Recently, as cash handled in an ATM is increased in denomination, there is proposed a bill handling apparatus, in which many bill storages are mounted to the extent possible. In a bill handling apparatus described in JP-A-8-221636, for example, plural bill storages are arranged in a lower portion of the apparatus in alignment in a longitudinal direction of the apparatus, and a bill receipt/payment port, a bill discrimination unit, a temporary holding box, and other mechanism parts are arranged together in an upper portion of the apparatus.

Denominations, which a bill handling apparatus can handle, correspond to the number of the bill storages. That is, as the number of the bill storages is increased, it is possible to handle many denominations. In case of the bill handling apparatus described in JP-A-8-221636, however, the bill handling apparatus is made large-sized in a longitudinal direction corresponding to the number of bill storages. Therefore, there has been demanded for a bill handling apparatus capable of corresponding to an increase in denomination while the apparatus is prevented from being made large-sized.

Meeting the demand described above, a bill storage provided therein with a plurality of receipt portions has been proposed as shown in JP-A-2008-152430. In the bill storage described in JP-A-2008-152430, it becomes possible to handle a plurality of denominations only by one bill storage. Therefore, without the extension of bill storages, it becomes possible to provide a bill handling apparatus capable of corresponding to an increase in denomination.

The bill storage disclosed in JP-A-2008-152430 comprises a bill inlet-outlet, through which a bill is taken out or received from the outside, a sorting gate, which switches connection of a conveyance path in order to distribute bills to destinations of conveyance, and a plurality of receipt portions including a taking-out and accumulating mechanism part (a feed roller, gate roller, etc.), which performs actions, in which bill is taken out and in which bill is accumulated. In the bill storage, an internal conveyance path, through which a bill is conveyed in a vertical direction of the bill storage, and a sorting gate, which distributes bills to destinations of receipt, and the sorting gate and the taking-out and accumulating mechanism part are arranged adjacent to each other in this order from the bill inlet-outlet.

That is, since the mechanism part is concentrated in the vicinity between the bill inlet-outlet and the receipt portions, the storage is increased in dimension in a longitudinal direction. Therefore, there has been a demand for realization of a bill storage provided therein with a plurality of receipt portions while the apparatus is prevented from becoming large in size.

### SUMMARY OF THE INVENTION

Meeting the demand described above, it is an object of the invention to miniaturize a bill storage provided therein with a plurality of receipt portions. Concretely, while a taking-out and accumulating mechanism part provided in a receipt portion nearest to a bill inlet-outlet and a sorting gate for switching of conveyance of bill are conventionally arranged adjacent to each other, the taking-out and accumulating mechanism part and the sorting gate are arranged separately.

According to the invention, it becomes possible to decrease a space between the sorting gate and the receipt portions. Therefore, a width of the bill storage, which has a plurality of receipt portions therein, in a longitudinal direction can be made as substantially small as that of a bill storage provided therein with a single receipt portion, which stores therein only one denomination.

Also, it becomes possible to optionally select and mount a bill storage, which has a plurality of receipt portions therein, or a bill storage, which has a single receipt portion therein, without a change in construction of the bill handling apparatus. Therefore, it becomes possible to provide a bill handling apparatus capable of flexibly accommodating an increase in denomination.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a perspective view showing an outline of an ATM as viewed from a front side thereof;

FIG. 2 is a perspective view showing the outline of the ATM as viewed from a back side thereof;

FIG. 3 is a control block diagram showing the control relationship of the ATM;

FIG. 4 is a view showing an internal construction of a bill handling apparatus;

FIG. 5 is a control block diagram showing the control relationship of the bill handling apparatus;

FIG. 6 is a side view showing a bill storage having a single receipt portion therein;

FIG. 7 is a side view showing an action, in which bills are accumulated in the receipt portion;

FIG. 8 is a side view showing an action, in which bills are taken out of the receipt portion;

FIG. 9 is a side view showing a bill storage having two receipt portions therein;

FIG. 10 is a side view showing a driving means of the bill storage having two receipt portions therein;

FIG. 11 is a side view showing an action, in which bills are accumulated in an upper receipt portion;

FIG. 12 is a side view showing an action, in which bills are accumulated in a lower receipt portion;

FIG. 13 is a side view showing an action, in which bills are taken out of the upper receipt portion;

FIG. 14 is a side view showing an action, in which bills are taken out of the lower receipt portion;

FIG. 15 is a perspective view showing an outline of a bill storage having two receipt portions therein;

FIG. 16 is a side view showing the bill storage when an upper door is opened;

FIG. 17 is a side view showing the bill storage when the upper door is closed;

FIG. 18 is a side view showing a bill storage having two receipt portions therein (another embodiment); and

FIG. 19 is a side view showing a bill storage having three receipt portions therein.

### DETAILED DESCRIPTION OF THE INVENTION

An embodiment of the invention will be described with reference to the drawings.

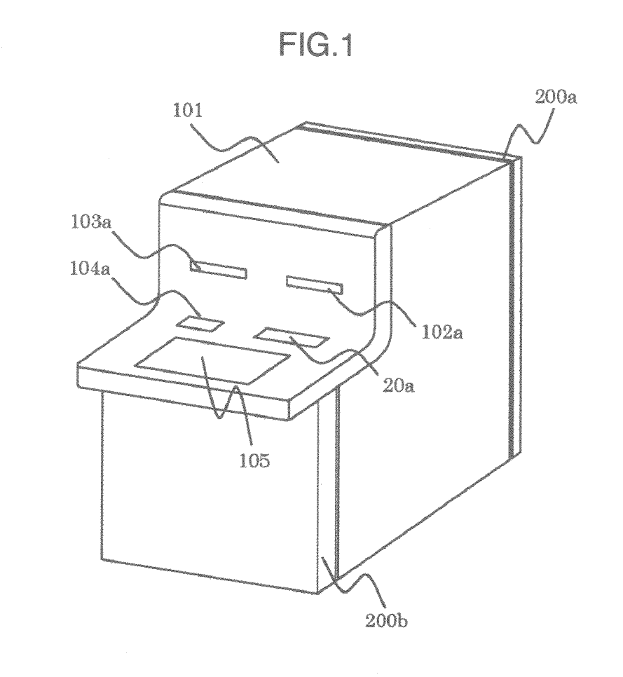

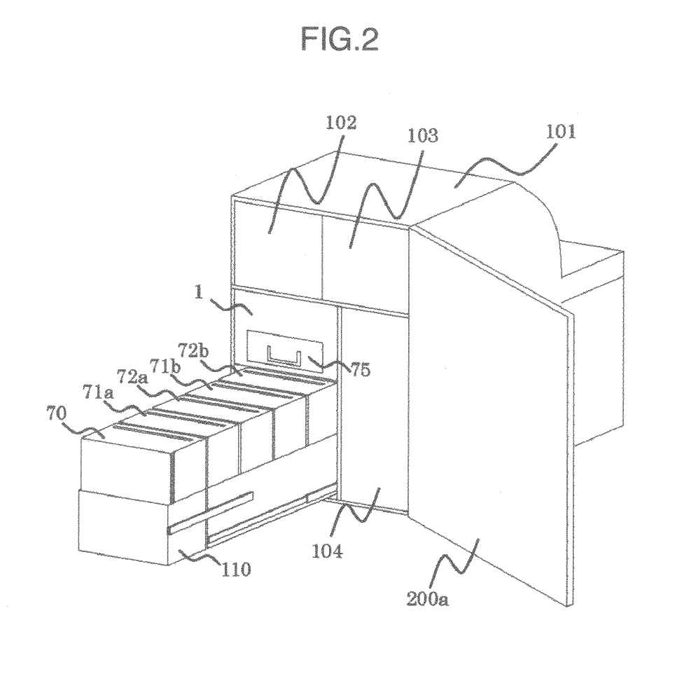

FIGS. 1 and 2, respectively, are perspective views showing an outline of an ATM as viewed from front and back sides thereof.

A card and account-slip processing device 102 is provided in an upper, right interior of an ATM 101 to be communicated with a card slot 102a to transact a user's card to print and discharge a transaction detail slip. A passbook transaction device 103 is provided in an upper, left interior of the ATM 101 to be communicated with a passbook slot 103a to transact a user's passbook to print and discharge a transaction detail slip.

Also, a bill handling apparatus 1 is provided in a lower, right interior of the ATM 101 to handle bills. The bill handling apparatus 1 is communicated with a bill receipt/payment port shutter 20a, through which a user charges and takes out bills and bill receipt and payment transactions are processed. A coin handling apparatus 104 is provided in a lower, left interior of the ATM 101 to handle coins. The coin handling apparatus 104 is communicated with a coin receipt/payment port shutter 104a to process coin receipt and payment transactions. In addition, the ATM 101 may be one with which the coin handling apparatus 104 is not provided.

Also, a customer operation unit 105 to display and input contents of a transaction is provided on the front of the ATM 101.

The bill handling apparatus 1 is provided with a tray 110 in a lower portion thereof as a portion, to which bill storages are mounted. Bill storages 70, 71a, 71b, 72a, 72b arranged in a row in a longitudinal direction of the ATM 101 are mounted detachably on the tray 110. In addition, while FIG. 2 shows a construction, in which a door 200a on the rear is opened to permit the tray 110 to be pulled out, a construction, in which a door 200b on the front is opened to permit the tray 110 to be pulled out, may apply.

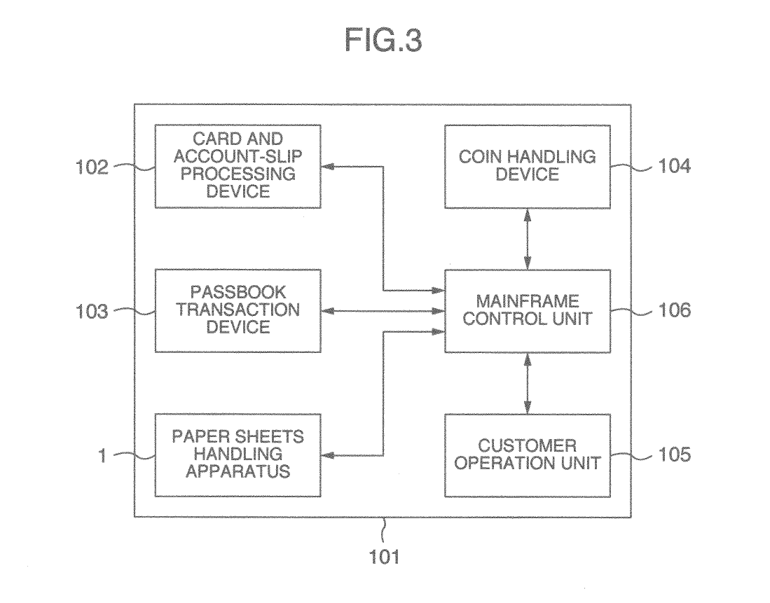

FIG. 3 is a control block diagram showing a control relationship of the ATM 101.

The ATM 101 comprises the card and account-slip processing device 102, the passbook transaction device 103, the bill receipt/payment machine 1, the coin handling apparatus 104, the customer operation unit 105, and a mainframe control unit 106. The card and account-slip processing device 102, the passbook transaction device 103, the bill receipt/payment machine 1, the coin handling apparatus 104, and the customer operation unit 105 perform necessary actions under the control of the mainframe control unit 106.

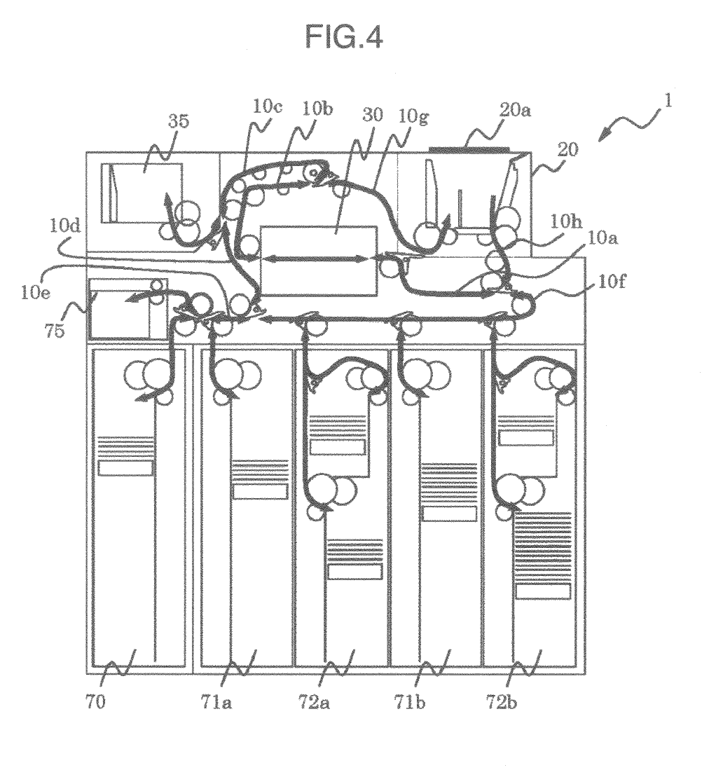

FIG. 4 is a side view showing an internal construction of the bill handling apparatus 1.

A bill receipt/payment port 20 is arranged on the front side (a side facing a user: an upper, right side in FIG. 4) of an upper portion of the bill handling apparatus 1. Also, a bill discrimination unit 30, which discriminates bills being received or taken out is arranged centrally of the bill handling apparatus 1 and a temporary holding box 35, which temporarily receives bills as received until realization of an associated transaction is arranged on an upper portion of the back side (an opposite side to the front side: an upper, left side in FIG. 4) of the bill handling apparatus 1. A reject box 75, which stores bills not presented to receipt and payment transactions, or bills left behind a customer is arranged below the temporary holding box 35. These mechanisms are connected together by two-way conveyance paths 10a to 10f, through which bills are conveyed two-way, and one-way conveyance paths 10g, 10h, through which bills are conveyed one-way.

Here, the bill discrimination unit 30 can discriminate denomination and truth or falsehood of both bills conveyed toward the rear from the front and bills conveyed toward the front from the rear. That is, the bill discrimination unit 30 can discriminate denomination and truth or falsehood of bills conveyed two-way and can determine whether bills should be rejected or not.

Bill storages 72b, 71b, 72a, 71a, which store bills, and a loading box 70, which performs loading and recovery of bills into the bill storages to function as a bill loading part are arranged from the front toward the rear in a lower portion of the bill handling apparatus 1. The bill storage 71 (71a and 71b) is one having a single receipt portion, which stores therein only one denomination. On the other hand, the bill storage 72 (72a and 72b) is one having two receipt portions therein.

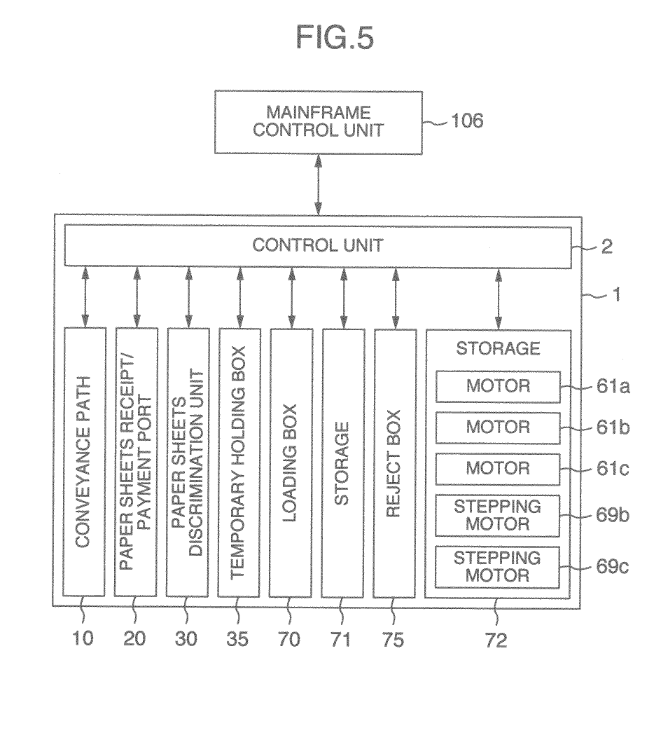

FIG. 5 is a control block diagram showing control relationship of the bill handling apparatus 1.

A control unit 2 of the bill handling apparatus 1 is connected to the mainframe control unit 106 of the ATM 101 to control the bill handling apparatus 1 according to a command from the mainframe control unit 106 and detection of a state of the bill handling apparatus 1. Also, the control unit 2 forwards the state of the bill handling apparatus 1 to the mainframe control unit 106 at need.

The bill handling apparatus 1 includes motors, solenoids, sensors, or the like for driving of the respective units (a conveyance path 10, the bill receipt/payment port 20, the bill discrimination unit 30, the temporary holding box 35, the loading box 70, the bill storages 71, 72, the reject box 75) and drivingly controls motors, solenoids, or the like while monitoring states of the units with the use of the sensors. In particular, the bill storage 72 having two receipt portions therein includes motors 61a to 61c serving as drive sources for conveyance, receiving and taking-out, or the like of bill and stepping motors 69b, 69c for actuation of the storage mechanisms, and the two receipt portions, respectively, can act independently.

The bill handling apparatus 1 constructed in the manner described above can carry out bill receipt and payment transactions.

Hereinafter, a case where the bill storages 71 and 72 are applied as recycling boxes for storage of bill for receipt and payment will be described. In addition, the bill storages 71 and 72 may be applied as the reject boxes described above or loading boxes.

First, actions of the bill storage 71 having a single receipt portion therein will be described.

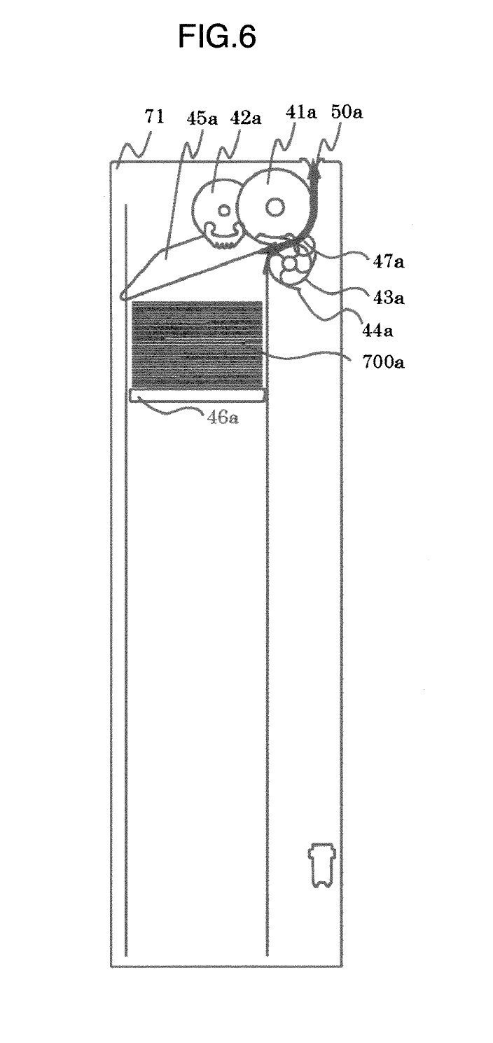

FIG. 6 is a view showing the bill storage 71 having a single receipt portion therein. The bill storage 71 includes a receipt portion 700a, which includes a taking-out and accumulating mechanism part, a push plate 46a, a pinch roller 47a, and a bill inlet-outlet 50a, which is provided on an upper surface of the bill storage near to a front surface thereof to transfer bills to an outside conveyance path.

A taking-out and accumulating mechanism part provided in the receipt portion 700a comprises a feed roller 41a, which rotates at a bill accumulating action and at a bill taking-out action to convey bills, a pick-up roller 42a, a gate roller 43a, which rotates at the bill accumulating action but does not rotate at the bill taking-out action, a brush roller 44a provided coaxially with the gate roller and having elastic members arranged radially, and a stack guide 45a movable at the bill accumulating action and at the bill taking-out action.

In addition, when the bill storage 71 functions only to accumulate bills, it may be constructed without the provision of the pick-up roller 42a. On the other hand, when the bill storage 71 functions only to take out bills, it may be constructed without the provision of the stack guide 45a.

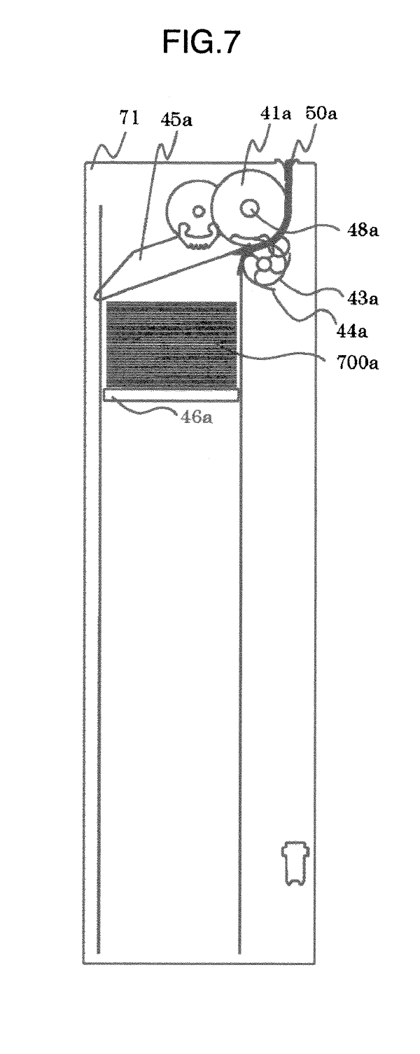

FIG. 7 is a view showing an action, in which bills are accumulated in the receipt portion 700a.

Bills conveyed into the bill storage 71 through the bill inlet-outlet 50a are discharged into the receipt portion 700a as the feed roller 41a and the gate roller 43a rotate.

Here, before bills are discharged into the receipt portion 700a, the push plate 46a is moved by a driving force of a stepping motor (not shown). The push plate 46a is controlled in moving in a direction, in which bills as stored descend, so as to ensure a space in the receipt portion. Subsequently, the stack guide 45a rotates pivotally about a feed roller shaft 48a and so the stack guide 45a is moved slantwise. The stack guide 45a is moved slantwise whereby bills discharged into the receipt portion 700a move along a slope of the stack guide 45a.

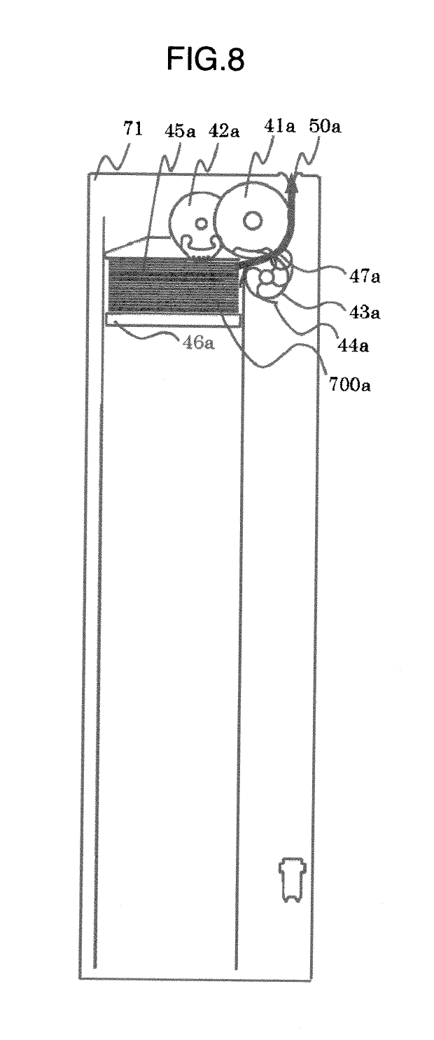

FIG. 8 is a view showing an action, in which bills are taken out of the receipt portion 700a.

The push plate 46a is moved upward by the driving force of the stepping motor (not shown). The push plate 46a is moved upward and so a force of a spring (not shown) or the like has bills on the stack guide 45a pushed against the pick-up roller 42a with a predetermined push force. In addition, while the case where the push plate 46a pushes bills has been described, a construction will do, in which the pick-up roller 42a pushes bills.

As described above, in a state, in which a push force acts between the pick-up roller 42a and bills, the pick-up roller 42a rotates whereby a bill in contact with the pick-up roller 42a can be taken out of the receipt portion 700a. Bills taken out of the receipt portion 700a are forwarded by the feed roller 41a, which rotates, and while the gate roller 43a, which does not rotate in a taking-out direction, prevents two sheets of bill from being forwarded at once, bills are conveyed one by one outside the bill storage through the pinch roller 47a from the bill inlet-outlet 50a. After a predetermined number of bills have been forwarded outside the bill storage, the feed roller 41 a is stopped.

Subsequently, actions of the bill storage 72 provided therein with two receipt portions will be described.

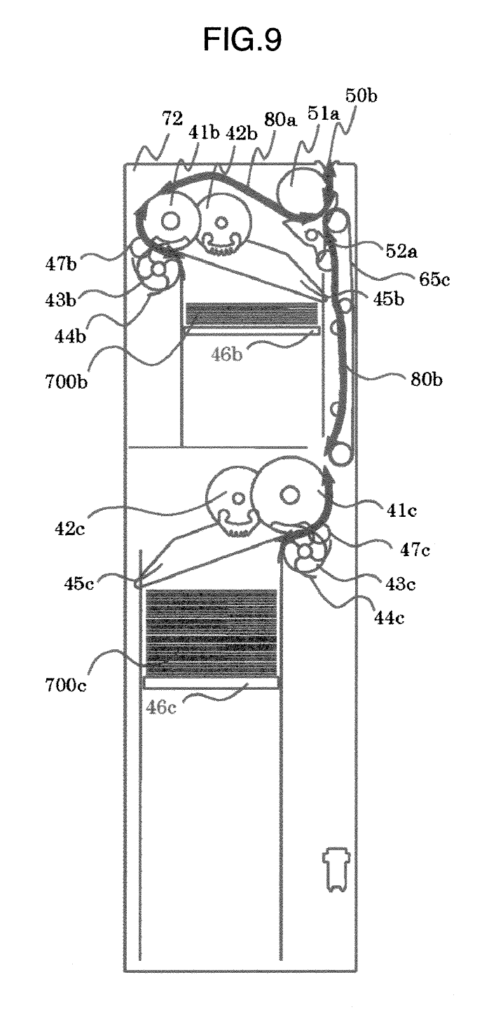

FIG. 9 is a view showing the bill storage 72 provided therein with two receipt portions. The bill storage 72 comprises an upper receipt portion 700b and a lower receipt portion 700c, each of which includes a taking-out and accumulating mechanism part, push plates 46b, 46c, pinch rollers 47b, 47c, and a bill inlet-outlet 50b provided on an upper surface of the bill storage near to a front surface thereof for performing bill transferring to and from the outside conveyance path. The upper receipt portion 700b and the lower receipt portion 700c are arranged in a state of being stacked in this order from the neighborhood of the bill inlet-outlet 50b.

Like the taking-out and accumulating mechanism part provided in the receipt portion 700a of the bill storage 71 provided therein with a single receipt portion, the taking-out and accumulating mechanism parts provided in the respective receipt portions 700 (700b, 700c) comprise a feed roller 41 (41b, 41c), a pick-up roller 42 (42b, 42c), a gate roller 43 (43b, 43c), a brush roller 44 (44b, 44c), and a stack guide 45 (45b, 45c). In particular, the upper receipt portion 700b is constructed to permit bills to enter into the receipt portion from a back side (on the left in FIG. 9) of the bill storage 72, and the taking-out and accumulating mechanism part provided in the receipt portion 700b is provided on the back side of the bill storage 72.

The bill inlet-outlet 50b is an inlet-outlet common to the upper receipt portion 700b and the lower receipt portion 700c, and a roller 51a is provided in a position adjacent to the inlet-outlet 50b to take bills into and outside the bill storage. By arranging the roller 51a, the feed roller 41b, and the gate roller 42b substantially in the same level, the upper receipt portion 700b is prevented from being decreased in volume.

The bill inlet-outlet 50b, the upper receipt portion 700b, and the lower receipt portion 700c are connected together by means of an internal conveyance path, through which bills can be bi-directionally conveyed. Concretely, the conveyance path comprises an internal conveyance path 80a, through which bills are conveyed substantially in a horizontal direction (a longitudinal direction of the bill storage) and an internal conveyance path 80b, through which bills are conveyed substantially in a vertical direction (a direction perpendicular to the longitudinal direction of the bill storage). The internal conveyance path 80b is constructed such that a width of the conveyance path in the longitudinal direction is made a necessity minimum by an arrangement, in which a driven roller is pushed against a conveyor belt 65c arranged on one side to convey bills. Also, a sorting gate 52a serving to distribute bills to the internal conveyance path 80a or the internal conveyance path 80b is arranged just below the roller 51a.

In addition, when the bill storage 72 only functions to accumulate bills, it may be constructed without the provision of the pick-up roller 42a (42b, 42c). On the other hand, when the bill storage 72 functions only to take out bills, it may be constructed without the provision of the stack guide 45 (45b, 45c). Also, when the bill storage 72 functions only to either accumulate or take out bills, the internal conveyance paths 80a and 80b may comprise a conveyance path, through which bills can be conveyed only one-way.

As shown in FIG. 9, while a taking-out and accumulating mechanism part provided on the upper receipt portion 700b is arranged on the back side of the bill storage 72, the bill inlet-outlet 50b, the sorting gate 52a, and the internal conveyance path 80b are arranged on the front side of the bill storage 72. The taking-out and accumulating mechanism part provided on the upper receipt portion 700b and the sorting gate 52a, respectively, are arranged in separate positions whereby it is made possible to decrease a space between the sorting gate 52a and the upper receipt portion 700b, thus leading to miniaturization of the bill storage 72. Also, the taking-out and accumulating mechanism part provided on the upper receipt portion 700b is arranged on the back side of the bill storage 72 and the bill inlet-outlet 50b is arranged on the front side of the bill storage 72 whereby a space just below the sorting gate 52a can also be made use of as a portion of a space in the upper receipt portion 700b. Therefore, even a bill storage having the sorting gate 52a can make efficient use of a space in the bill storage to lead to miniaturization of the bill storage 72.

In addition, as described above, the taking-out and accumulating mechanism part provided on the upper receipt portion 700b is arranged on the back side of the bill storage 72 and the space between the sorting gate 52a and the upper receipt portion 700b is made small, with the result that the upper receipt portion 700b is arranged in offset toward the front side of the bill storage 72 (on the right side in FIG. 9). On the other hand, the lower receipt portion 700c is arranged offset toward the back side of the bill storage 72 since its taking-out and accumulating mechanism part is provided on the front side of the bill storage 72.

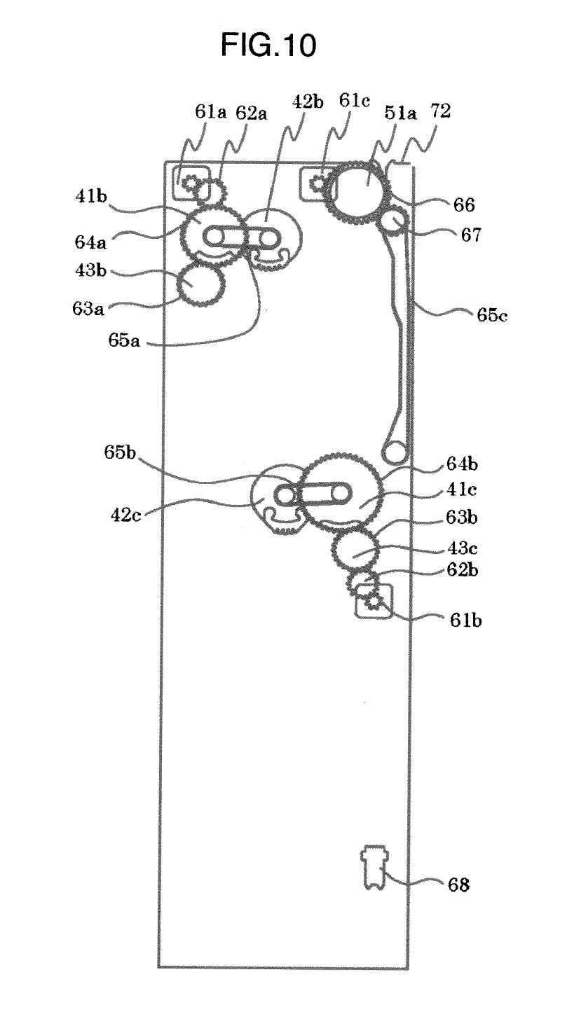

FIG. 10 is a view showing taking-out and accumulating operation parts, the roller 51a, and driving means of the conveyor belt 65c, which are provided on the upper receipt portion 700b and on the lower receipt portion 700c. Out of the taking-out and accumulating operation parts, driving is transmitted to the feed roller 41 (41b, 41c) and the gate roller 43 (43b, 43c) through a driving transfer gear 62 (62a, 62b), a driving transfer gear 63 (63a, 63b), and a driving transfer gear 64 (64a, 64b) from a DC motor 61 (61a, 61b). Also, driving is transmitted to the pick-up roller 42 through the driving transfer gear 62 (62a, 62b), the driving transfer gear 64 (64a, 64b), and a timing belt 65 (65a, 65b) from the DC motor 61 (61a, 61b). Further, driving is transmitted to the roller 51a and the conveyor belt 65c through a driving transfer gear 66 and a driving transfer gear 67 from a DC motor 61c.

In addition, supplying of electricity to the DC motor and sending/receiving of electric signals by sensors (not shown) are conducted through a connector 68 provided on a lower portion of the bill storage 72.

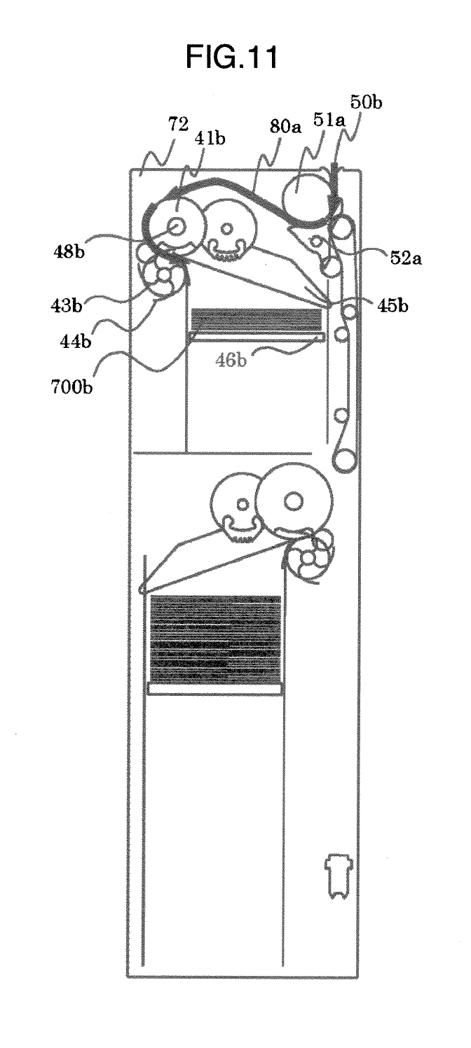

FIG. 11 is a view showing an action, in which bills are accumulated in the upper receipt portion 700b.

Bills conveyed into the bill storage 72 through the bill inlet-outlet 50b are conveyed onto the internal conveyance path 80a by the roller 51a and the sorting gate 52a. Thereafter, bills are changed in a direction of conveyance by the feed roller 41b in a manner to have both sides thereof turned over and discharged into the upper receipt portion 700b.

Here, before bills are discharged into the upper receipt portion 700b, the push plate 46b is moved by a driving force of the stepping motor 69b (not shown). The push plate 46b is controlled in moving in a direction, in which bills as stored descend, so as to ensure a space in the receipt portion. Subsequently, the stack guide 45b rotates pivotally about a feed roller shaft 48b and so the stack guide 45b is moved slantwise. The stack guide 45b is moved slantwise whereby bills discharged into the upper receipt portion 700b move along a slope of the stack guide 45b. Also, speed, at which bills are taken in by the feed roller 41b, is preferably greater than or equal to speed, at which bills are conveyed along the internal conveyance path 80a, and is made substantially equal thereto in this embodiment.

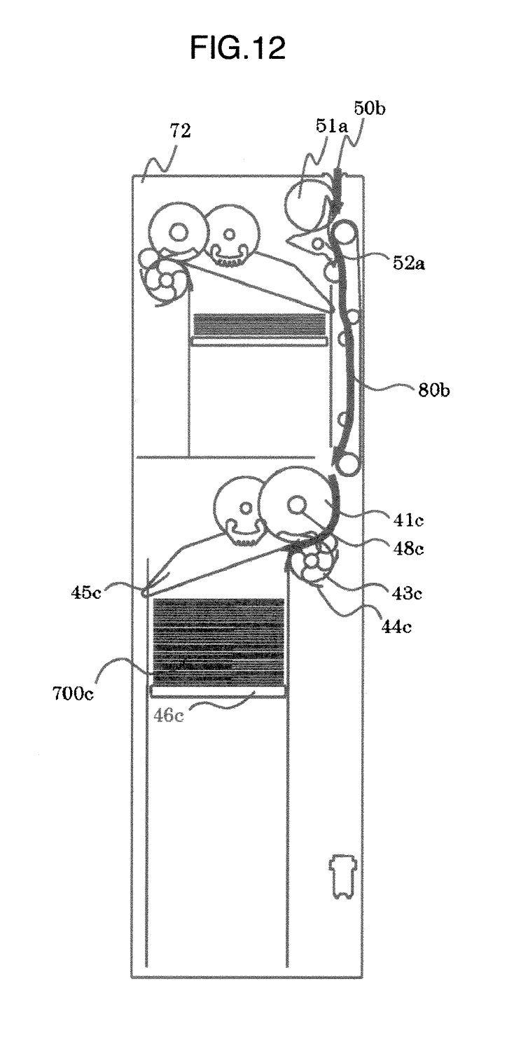

FIG. 12 is a view showing an action, in which bills are accumulated in the lower receipt portion 700c.

Bills conveyed into the bill storage 72 through the bill inlet-outlet 50b are conveyed onto the internal conveyance path 80b by the roller 51a and the sorting gate 52a. Thereafter, bills are discharged into the lower receipt portion 700c by the feed roller 41c.

Here, before bills are discharged into the lower receipt portion 700c, the push plate 46c is moved by a driving force of the stepping motor 69c (not shown). The push plate 46c is controlled in moving in a direction, in which bills as stored descend, so as to ensure a space in the receipt portion. Subsequently, the stack guide 45c rotates pivotally about a feed roller shaft 48c and so the stack guide 45c is moved slantwise. The stack guide 45c is moved slantwise whereby bills discharged into the lower receipt portion 700c move along a slope of the stack guide 45c. Also, speed, at which bills are taken in by the feed roller 41c, is preferably greater than or equal to speed, at which bills are conveyed along the internal conveyance path 80b, and is made substantially equal thereto in this embodiment.

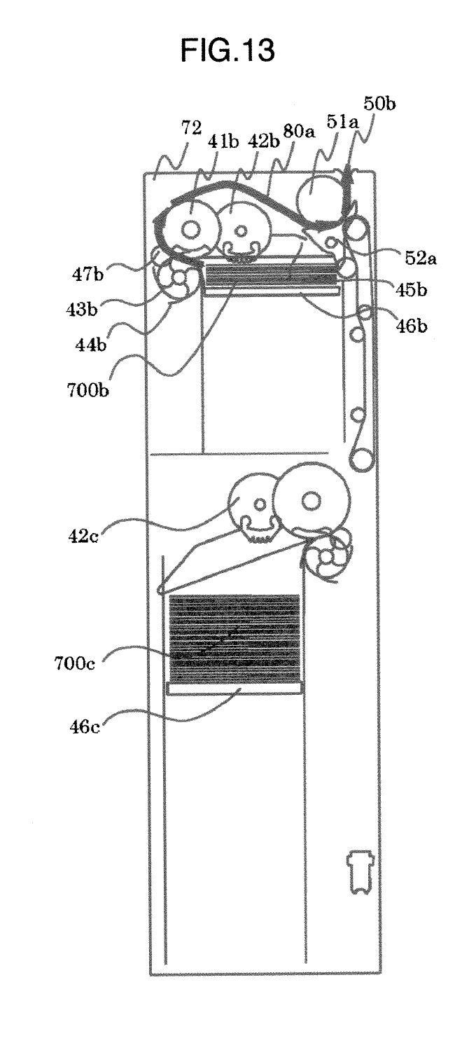

FIG. 13 is a view showing an action, in which bills are taken out of the upper receipt portion 700b.

The push plate 46b is moved upward by a driving force of the stepping motor 69b (not shown). The push plate 46b is moved upward and so a force of a spring (not shown) or the like has bills on the stack guide 46b pushed against the pick-up roller 42b with a predetermined push force. On the other hand, within the lower receipt portion 700c, in a manner to prevent bills from being taken out, the pick-up roller 42c causes the push plate 46c to descend to a position in no contact with bills in the lower receipt portion 700c.

Bills taken out of the upper receipt portion 700b by the pick-up roller 42b are forwarded by the feed roller 41b, which rotates, and while the gate roller 43b, which does not rotate in a taking-out direction, prevents two bills from being forwarded at once, bills are forwarded onto the internal conveyance path 80a through the pinch roller 47b. Thereafter, bills are conveyed one by one outside the bill storage from the bill inlet-outlet 50b by the roller 51a and the sorting gate 52a.

After a predetermined number of bills have been forwarded onto the internal conveyance path 80a, the feed roller 41b is stopped. Then, after all bills on the internal conveyance path 80a are conveyed outside the bill storage, the internal conveyance path 80a and the roller 51a are stopped.

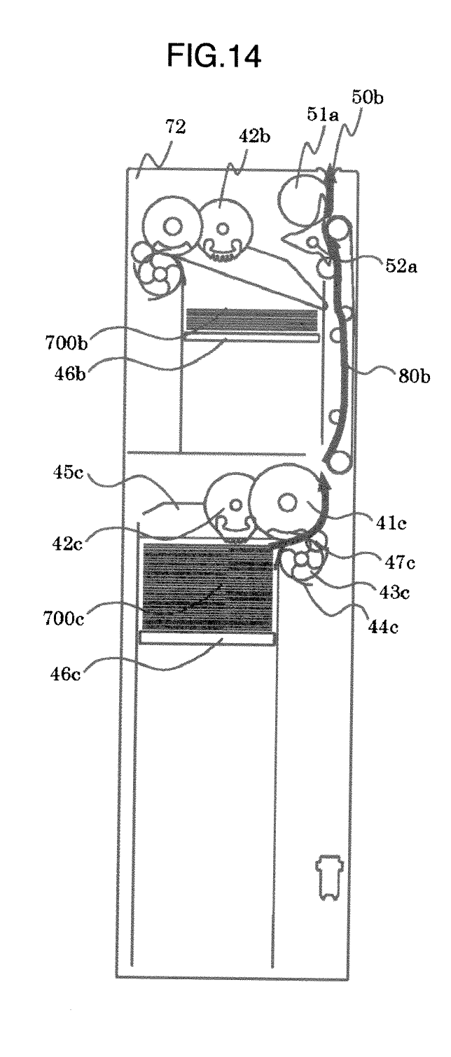

FIG. 14 is a view showing an action, in which bills are taken out of the lower receipt portion 700c.

The push plate 46c is moved upward by a driving force of the stepping motor 69c. The push plate 46c is moved upward and so a force of a spring (not shown) or the like has bills on the push plate 46c pushed against the pick-up roller 42c with a predetermined push force. On the other hand, within the lower receipt portion 700b, in a manner to prevent bills from being taken out, the pick-up roller 42b causes the push plate 46b to descend to a position in no contact with bills in the lower receipt portion 700b.

Bills pushed against the pick-up roller 42c are forwarded by the feed roller 41c, which rotates, and while the gate roller 43c, which does not rotate in a taking-out direction, prevents two bills from being forwarded at once, bills are forwarded onto the conveyance path 80b. Thereafter, bills are conveyed one by one outside the bill storage from the bill inlet-outlet 50b by the roller 51a and the sorting gate 52a.

After a predetermined number of bills have been forwarded onto the conveyance path 80b, the feed roller 41c is stopped. Then, after all bills on the conveyance path 80b are conveyed outside the bill storage, the conveyance path 80b and the roller 51a are stopped.

The respective bill storages 71, 72 in the bill handling apparatus constructed in a manner described above are constructed to be common to each other in outside dimension, in a position of the bill inlet-outlet (50a, 50b), in the shape of the bill inlet-outlet, and so on. Thereby, it is possible to provide interchangeability to the respective bill storages 71, 72, so that it is possible to freely change the combination of the bill storages 71, 72 to mount the same on the tray 110 according to the situation of application in respective countries.

For example, while bills circulated in Japan include four kinds of bill, that is, 10,000-yen note, 5,000-yen note, 2,000-yen note, and 1,000-yen note, application can be made such that 10,000-yen notes and 1,000-yen notes, which are large in amount of circulation, can be stored in the bill storage 71 provided therein with a single receipt portion and 5,000-yen notes and 2,000-yen notes, which are small in amount of circulation, can be stored together in the bill storage 72 provided therein with two receipt portions.

Next, a door, which is provided on the bill storage 72 in order to permit bills to be charged into and taken out of the upper receipt portion 700b and the lower receipt portion 700c will be described.

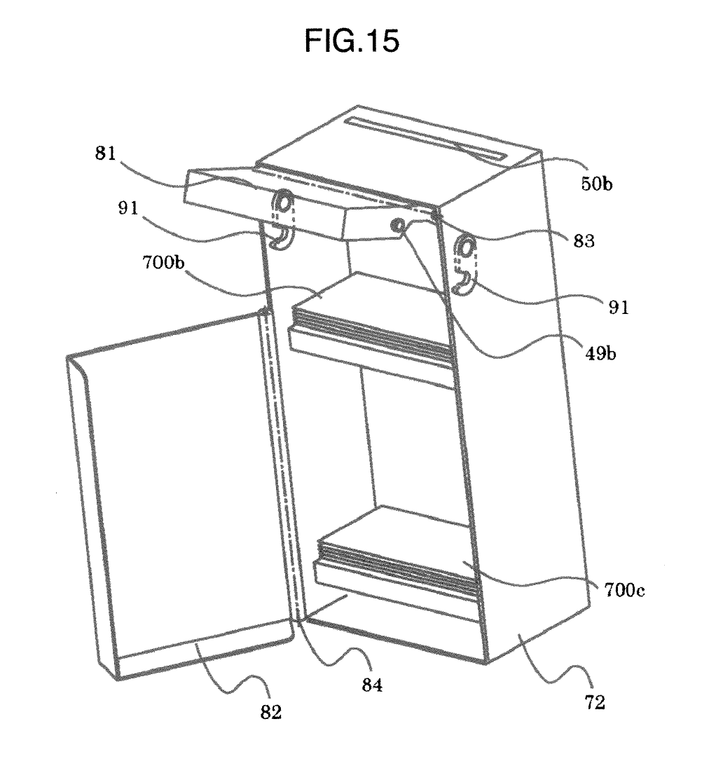

FIG. 15 is a perspective view showing an appearance of the bill storage 72. The bill storage 72 is provided with an upper door 81, through which bills are charged into and taken out of the upper receipt portion 700b, and a lower door 82, through which bills are charged into and taken out of the bill receipt portion 700c. The upper door 81 and the lower door 82, which are provided on the back side of the bill storage, can be opened and dosed independently of each other and enable bills to be charged into and taken out of the upper receipt portion 700b and the lower receipt portion 700c as need arises.

Also, the upper door 81 is constructed to turn about a rotating shaft 83 as a fulcrum to be opened and closed (referred below to as vertical opening), and the lower door 82 is constructed to turn about a rotating shaft 84, which is arranged at a corner of the bill storage 72, as a fulcrum to be opened and closed (referred below to as horizontal opening). That is, the upper door 81 and the lower door 82 are different from each other in directions of opening and closing.

The reason why the upper door 81 adopts vertical opening will be described. Since the feed roller 43b and the stack guide 45b are interlocked with each other through the feed roller shaft 48b, the feed roller 41b is desirably left in the bill storage 72 irrespective of opening and closing of the upper door 81. Also, in the case where the gate roller 43b is disposed in the interior of the bill storage 72, it is difficult for a user to take in and out bills, so that it is desirable to interlockingly retreat the gate roller 43b and the upper door 81.

As described above, in the case where the feed roller 41b is left in the interior of the receipt box and the gate roller 43b is caused to interlock with the upper door 81, it is possible in tentatively horizontal opening of the upper door 81 that, for example, when errors are involved due to tolerance in design, secular change, or the like, the feed roller shaft 48b and a gate roller shaft 49b are made offset in a direction of intersection to cause an obstacle in conveyance of bill. On the other hand, in a construction, in which the upper door 81 adopts vertical opening, the problems described above are hard to occur even when errors are involved due to tolerance in design, secular change, or the like.

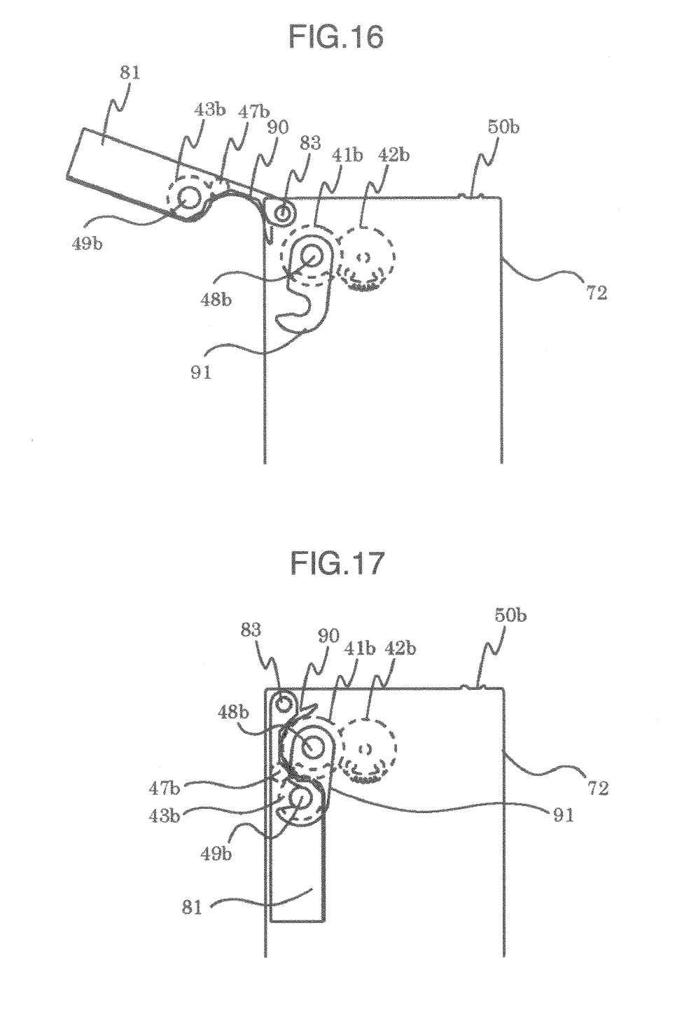

FIGS. 16 and 17 are views showing the bill storage 72 when the upper door 81 is opened and when the upper door 81 is closed. At this time, the gate roller 43b, the pinch roller 47b, and a conveyance guide 90 to the upper receipt portion 700b interlock with the upper door 81 to retreat, so that it is easy for a user to take in and out bills in loading and taking out bills.

Also, a shaft positioning plate 91 is arranged in two locations inside the bill storage 72 and outside the internal conveyance path 80a of bill. The shaft positioning plate 91 precisely fixes a center distance between the feed roller shaft 48b and the gate roller shaft 49b. In order to decrease a force required for opening and closing the door 82, a contact area between the shaft positioning plate 91 and the gate roller shaft 49b is made a necessity minimum to an extent capable of interposition of the gate roller shaft 49b.

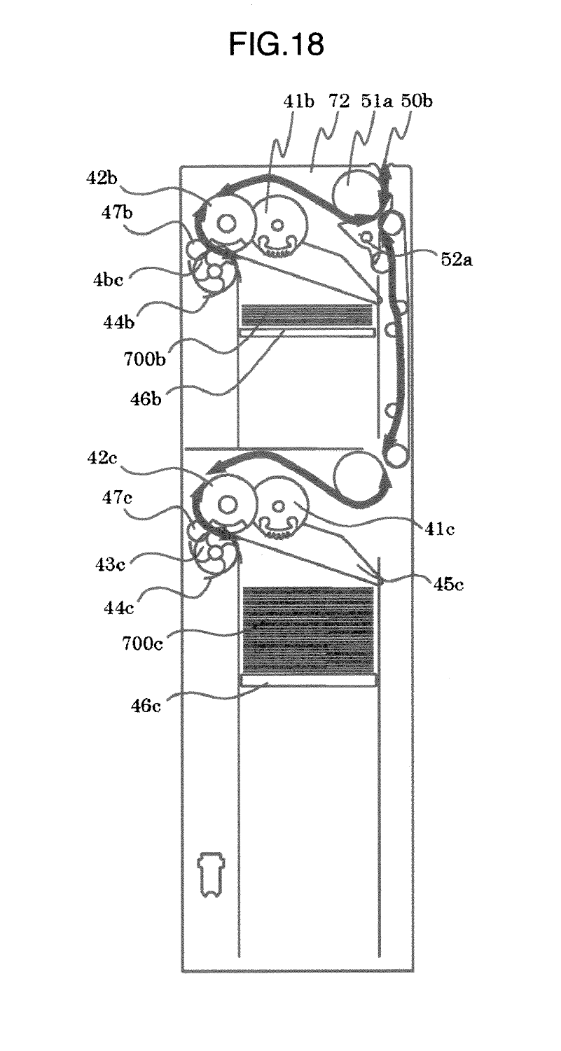

In addition, in the embodiment described above, the taking-out and accumulating mechanism part (41c to 45c) provided in the lower receipt portion 700c is arranged substantially vertically downwardly of the bill inlet-outlet 50b, but it may be arranged substantially vertically downwardly of the taking-out and accumulating mechanism part (41b to 45b) provided in the upper receipt portion 700b as shown in FIG. 18.

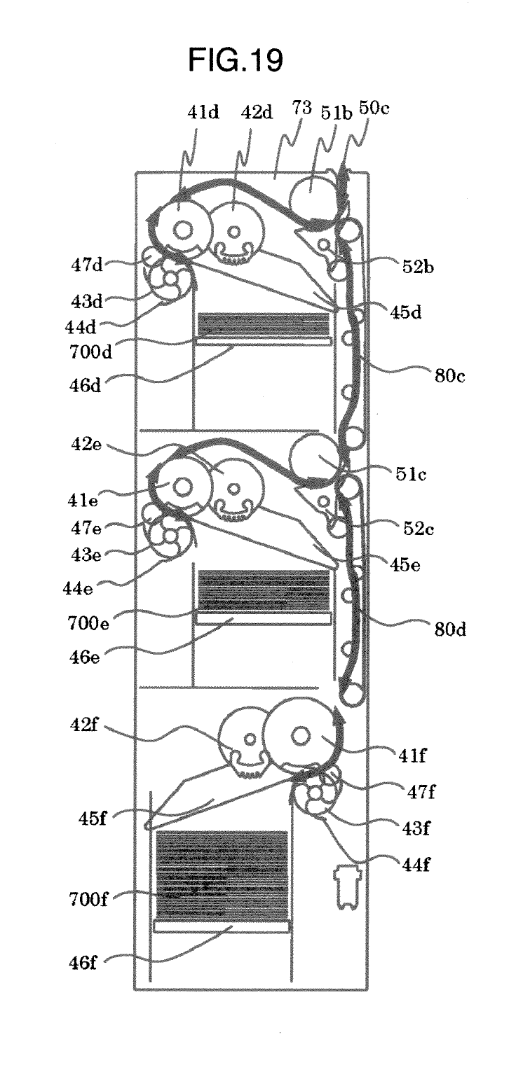

Also, as shown in FIG. 19, the bill storage may have three receipt portions therein. With the bill storage 73, which has three receipt portions therein, a taking-out and accumulating mechanism part (41d to 45d (41e to 45e)) provided in an upper receipt portion 700d (an intermediate receipt portion 700e) is arranged on a side horizontally opposed to a bill inlet-outlet 50c, a sorting gate 52b (52c), and an internal conveyance path 80c (80d) with an upper receipt portion 700d (an intermediate receipt portion 700e) therebetween.

By adopting the construction described above, a width of a bill storage, which has a plurality of receipt portions therein, in a longitudinal direction can be made as substantially small as that of a bill storage provided therein with a single receipt portion, which stores therein only one denomination. Also, by optionally selecting a bill storage, which has a plurality of receipt portions therein, or a bill storage, which has a single receipt portion therein, to mount the same on the tray 110, it is possible to provide a bill handling apparatus, which can flexibly conform to the situation of application in respective countries.

It should be further understood by those skilled in the art that although the foregoing description has been made on embodiments of the invention, the invention is not limited thereto and various changes and modifications may be made without departing from the spirit of the invention and the scope of the appended claims.

1. A bill storage comprising: a plurality of bill receipt portions provided therein; a bill inlet-outlet, which is provided on an upper surface of the bill storage and through which bills are taken out or received from outside; and a taking-out and accumulating mechanism part provided on each of the receipt portions to perform actions, in which bills are taken out and in which bills are accumulated, wherein
at least a first bill receipt portion and a second bill receipt portion are arranged in a state of being stacked in this order from a side of the bill inlet-outlet,
said bill inlet-outlet is provided on a predetermined side, and
said taking-out and accumulating mechanism part provided on the first bill receipt portion is arranged on another side opposed to said predetermined side
wherein a door, through which bills in the respective bill receipt portions are charged and taken out, is provided on said another side, and
wherein the gate roller on the first taking-out and accumulating mechanism part moves together with the door, through which bills in the first bill receipt portion are charged and taken out.

2. The bill storage according to claim 1, further comprising a sorting gate, by which conveyance of bill between the bill inlet-outlet and the first bill receipt portion and conveyance between the bill inlet-outlet and the second bill receipt portion are switched, the sorting gate being arranged on said predetermined side.

3. The bill storage according to claim 1, further comprising a plurality of internal conveyance paths, through which bills are conveyed bidirection between the bill inlet-outlet and the respective receipt portions,
the plurality of internal conveyance paths comprising a first internal conveyance path, through which bills are conveyed substantially in a horizontal direction, and a second internal conveyance path, through which bills are conveyed substantially in a vertical direction, and
the second internal conveyance path being provided on said predetermined side.

4. The bill storage according to claim 3, characterized in that wherein bills conveyed to the first internal conveyance path are received in the first bill receipt portion with front and back sides thereof reversed.

5. The bill storage according to claim 3, characterized in that bills conveyed to the first internal conveyance path are received horizontally in the first bill receipt portion.

6. The bill storage according to claim 1, characterized in that the respective taking-out and accumulating mechanism parts are provided individually with drive means for driving the taking-out and accumulating mechanism parts.

7. The bill storage according to claim 1, characterized in that the taking-out and accumulating mechanism parts comprise at least a feed roller, which rotates in a bill accumulating action and a bill taking-out action to convey bills and a gate roller, which rotates in the bill accumulating action but does not rotate in the bill taking-out action.

8. A bill storage comprising:
a plurality of bill receipt portions provided therein;
a bill inlet-outlet, which is provided on an upper surface of the bill storage and through which bills are taken out or received from the outside; and
a plurality of internal conveyance paths, through which bills are conveyed bidirection between the bill inlet-outlet and the respective bill receipt portions,
wherein at least a first bill receipt portion and a second bill receipt portion are arranged in a state of being stacked in this order from a side of the bill inlet-outlet,
characterized in that
the first bill receipt portion is arranged offset toward a predetermined side, and the second bill receipt portion is arranged offset toward another side opposed to the predetermined side,
wherein a door, through which bills in the respective bill receipt portions are charged and taken out, is provided on said another side, and
wherein the gate roller on the first taking-out and accumulating mechanism part moves together with the door, through which bills in the first bill receipt portion are charged and taken out.

9. A bill handling apparatus comprising:
a bill receipt/payment port, which hill receipt/payment by a user is permitted;
a bill discrimination unit, which discriminates bills being received or paid;
a conveyance path, through which bills are conveyed; and
a mounting portion, on which the bill storage according to claim 1 is mounted,
the mounting portion being constructed so that a bill storage provided with only one bill receipt portion having a taking-out and accumulating mechanism part, which performs actions, in which bills are taken out and in which bills are accumulated and the bill storage according to claim I are optionally selected and mounted.
